(19) United States
(12) Patent Application Publication
(10) Pub. No.: US 2007/0211574 A1
(43) Pub. Date: Sep. 13, 2007

(54) Parametric Loudspeaker System And Method For Enabling Isolated Listening To Audio Material

(76) Inventor: James J Croft III, Poway, CA (US)

Correspondence Address: THORPE NORTH & WESTERN, LLP., 8180 SOUTH 700 EAST, SUITE 350, SANDY, UT, 84070, US

(21) Appl. No.: 10/575,672

(22) PCT Filed: Oct. 8, 2004
(86) PCT No.: PCT/US04/33308

§ 371 Date: Dec. 28, 2006

Related U.S. Application Data
(60) Provisional application No. 60/509,731, filed on Oct. 8, 2003.

(51) Int. Cl. G10K 11/00

(52) U.S. Cl. 367/197

(57) ABSTRACT

A virtual headset for enabling isolated listening to audio material by a listener without need for earphones or other physical audio producing devices attached to the listener. The virtual headset includes a parametric ultrasonic signal source 504 supplying at least a first parametric ultrasonic channel signal comprised of an ultrasonic carrier signal and at least one sideband, and configured to be emitted and directed substantially exclusively at a first ear 506 of the listener 502. The parametric ultrasonic signal source is coupled to an electro-acoustical emitter structure, which is configured to emit and direct a first parametric ultrasonic wave corresponding to the first parametric ultrasonic channel signal at the listener such that a first resultant decoupled audio wave will be heard substantially exclusively at the first ear of the listener, with minimal audible sound at a second ear 514 of the listener.

### BACKGROUND OF THE INVENTION

1. Field of the Invention

The present invention relates generally to the field of parametric loudspeakers. More particularly, the present invention relates to a multi-channel parametric loudspeaker system, wherein individual channels are detected differentially by a listener or at individual reception points.

2. Related Art

Audio reproduction has long been considered a well-developed technology. Over the decades, sound reproduction devices have moved from a mechanical needle on a tube or vinyl disk, to analog and digital reproduction over laser and many other forms of electronic media. Advanced computers and software now allow complex programming of signal processing and manipulation of synthesized sounds to create new dimensions of listening experience, including applications within movie and home theater systems. Computer generated audio is reaching new heights, creating sounds that are no longer limited to reality, but extend into the creative realms of imagination.

Nevertheless, the actual reproduction of sound at the interface of electro-mechanical speakers with the air has remained substantially the same in principle for almost one hundred years. Such speaker technology is clearly dominated by dynamic speakers, which constitute more than 90 percent of commercial speakers in use today. Indeed, the general class of audio reproduction devices referred to as dynamic speakers began with the simple combination of a magnet, voice coil and cone, driven by an electronic signal. The magnet and voice coil convert the variable voltage of the signal to mechanical displacement, representing a first stage within the dynamic speaker as a conventional multistage transducer. The attached cone provides a second stage of impedance matching between the electrical transducer and air envelope surrounding the transducer, enabling transmission of small vibrations of the voice coil to emerge as expansive compression waves that can fill an auditorium. Such multistage systems comprise the current fundamental approach to reproduction of sound, particularly at high energy levels.

A lesser category of speakers, referred to generally as film or diaphragmatic transducers, relies on movement of an emitter surface area of film that is typically generated by electrostatic or planar magnetic driver members. Although electrostatic speakers have been an integral part of the audio community for many decades, their popularity has been quite limited. Typically, such film emitters are known to be low-power output devices having applications appropriate only to small rooms or confined spaces. With a few exceptions, commercial film transducers have found primary acceptance as tweeters and other high frequency devices in which the width of the film emitter is equal to or less than the propagated wavelength of sound. Attempts to apply larger film devices have resulted in poor matching of resonant frequencies of the emitter with sound output, as well as a myriad of mechanical control problems such as maintenance of uniform spacing from the stator or driver, uniform application of electromotive fields, phase matching, frequency equalization, etc.

As with many well-developed technologies, advances in the state of the art of sound reproduction have generally been limited to minor enhancements and improvements within the basic fields of dynamic and electrostatic systems. Indeed, substantially all of these improvements operate within the same fundamental principles that have formed the basics of well-known audio reproduction. These include the concept that (i) sound is generated at a speaker face, (ii) based on reciprocating movement of a transducer (iii) at frequencies that directly stimulate the air into the desired audio vibrations. From this basic concept stems the myriad of speaker solutions addressing innumerable problems relating to the challenge of optimizing the transfer of energy from a dense speaker mass to the almost massless air medium that must propagate the sound.

A second fundamental principle common to prior art dynamic and electrostatic transducers is the fact that sound reproduction is based on a linear mode of operation. In other words, the physics of conventional sound generation rely on mathematics that conform to linear relationships between absorbed energy and the resulting wave propagation in the air medium. Such characteristics enable predictable processing of audio signals, with an expectation that a given energy input applied to a circuit or signal will yield a corresponding, proportional output when propagated as a sound wave from the transducer.

In such conventional systems, maintaining the air medium in a linear mode is extremely important. If the air is driven excessively into a nonlinear state, severe distortion occurs and the audio system is essentially unacceptable. This nonlinearity occurs when the air molecules adjacent the dynamic speaker cone or emitter diaphragm surface are driven to excessive energy levels that exceed the ability of the air molecules to respond in a corresponding manner to speaker movement. In simple terms, when the air molecules are unable to match the movement of the speaker so that the speaker is loading the air with more energy than the air can dissipate in a linear mode, then a nonlinear response occurs, leading to severe distortion and speaker inoperability. Conventional sound systems are therefore built to avoid this limitation, ensuring that the speaker transducer operates strictly within a linear range.

Parametric sound systems, however, represent an anomaly in audio sound generation. Instead of operating within the conventional linear mode, parametric sound can only be generated when the air medium is driven into a nonlinear state. Within this unique realm of operation, audio sound is not propagated from the speaker or transducer element. Instead, the transducer is used to propagate carrier waves of high-energy, ultrasonic bandwidth beyond human hearing. The ultrasonic wave therefore functions as the carrier wave, which can be modulated with audio input that develops sideband characteristics capable of decoupling in air when driven to the nonlinear condition. In this manner, it is the air molecules and not the speaker transducer that will generate the audio component of a parametric system. Specifically, it is the sideband component of the ultrasonic carrier wave that energizes the air molecule with audio signal, enabling eventual wave propagation at audio frequencies.

Another fundamental distinction of a parametric speaker system from that of conventional audio is that high-energy transducers as characterized in prior art audio systems do not appear to provide the necessary energy required for effective parametric speaker operation. For example, the dominant dynamic speaker category of conventional audio systems is well known for its high-energy output. Clearly, the capability of a cone/magnet transducer to transfer high-energy levels to surrounding air is evident from the fact that virtually all high-power audio speaker systems currently in use rely on dynamic speaker devices. In contrast, low output devices such as electrostatic and other diaphragm transducers are virtually unacceptable for high-power requirements. As an obvious example, consider the outdoor audio systems that service large concerts at stadiums and other outdoor venues. Normally, massive dynamic speakers are necessary to develop direct audio to such audiences. To suggest that a low-power film diaphragm might be applied in this setting would be considered foolish and impractical.

Yet in parametric sound production, the present inventors have surprisingly discovered that a film emitter will outperform a dynamic speaker in developing high-power, parametric audio output. Indeed, it has been the general experience of the present inventors that efforts to apply conventional audio practices to parametric devices will typically yield unsatisfactory results. This has been demonstrated in attempts to obtain high sound pressure levels, as well as minimal distortion, using conventional audio techniques. It may well be that this prior art tendency of applying conventional audio design to construction of parametric sound systems has frustrated and delayed the successful realization of commercial parametric sound. This is evidenced by the fact that prior art patents on parametric sound systems have utilized high-energy, multistage-like bimorph transducers comparable to conventional dynamic speakers. Despite widespread, international studies in this area, none of these parametric speakers were able to perform in an acceptable manner.

In summary, whereas conventional audio systems rely on well accepted acoustic principles of (i) generating audio waves at the face of the speaker transducer, (ii) based on a high-energy output device such as a dynamic speaker, (iii) while operating in a linear mode, the present inventors have discovered that just the opposite design criteria are preferred for parametric applications. Specifically, effective parametric sound is effectively generated using (i) a comparatively low-energy film diaphragm, (ii) in a nonlinear mode, (iii) to propagate an ultrasonic carrier wave with a modulated sideband component that is decoupled in air (iv) at extended distances from the face of the transducer. In view of these distinctions, it is not surprising that much of the conventional wisdom developed over decades of research in conventional audio technology is simply inapplicable to problems associated with the generation parametric sound.

In particular to the present invention, many attempts have been made to create multi-channel surround sound systems. From the time of the introduction of two-channel stereo, there has been a frustration caused by having to use more than one speaker structure to reproduce more than one channel. Current surround sound systems now utilize five or more speakers per system. This places undesirable demands on the aesthetics of the domestic environment and increases the complexity of system installation. Further, there is often a situation where the ideal location for a particular speaker channel is not available, particularly for the surround channels, which often must be hung on rear or sidewalls, ideally in a symmetrical fashion about the listener.

Because of the above problems, there has been a long felt need to integrate more than one channel of projection into a single loudspeaker structure. Previous attempts have fallen by the wayside due to poor simulation of a stereo system. Besides failing in a stereo application, the previous attempts were not designed to address modem multi-channel requirements of three or more channels.

Furthermore, nearly all multi-channel systems are unable to produce true binaural sound, because when multiple conventional speakers emit sound, crosstalk amongst the speakers inherently exists because they are substantially omnidirectional in nature. True binaural sound can be created when independent sound waves are delivered exclusively to each ear of a listener. By controlling the sound that each ear can hear, impressive results may be realized, such as allowing the listener to pinpoint a virtual source of sound. Because of the crosstalk existing in the output of conventional multi-channel speaker systems, it has been exceedingly difficult to produce binaural sound without resorting to the use of headphones worn by the listener. Extensive and complex cross-talk cancellation techniques have been employed in an attempt to generate true binaural sound with conventional loudspeakers.

Similarly, multi-channel parametric devices have not been implemented successfully due to acoustic outputs that were too low when the parametric devices are reasonably sized for each individual channel. If such multiple parametric devices were made larger for a multi-channel system, the large devices would take up too much space and cause a significant increase in cost.

What is needed is a sound projector that can deliver multi-channel sound into an environment simulating multiple speaker locations, and generate true binaural sound.

### SUMMARY OF THE INVENTION

It has been recognized that it would be advantageous to develop a system which provides the benefits of headphones, such as isolated listening, without the requirement of sound producing devices attached to the head or body of the listener.

The invention provides a virtual headset for enabling isolated listening to audio material by a listener without need for earphones or other physical audio producing devices attached to the listener. The virtual headset includes a parametric ultrasonic signal source supplying at least a first parametric ultrasonic channel signal comprised of an ultrasonic carrier signal and at least one sideband, and configured to be emitted and directed substantially exclusively at a first ear of the listener. The parametric ultrasonic signal source is coupled to an electro-acoustical emitter structure, which is configured to emit and direct a first parametric ultrasonic wave corresponding to the first parametric ultrasonic channel signal at the listener such that a first resultant decoupled audio wave will be heard substantially exclusively at the first ear of the listener, with minimal audible sound at a second ear of the listener.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1a is a reference diagram for FIGS. 1b, 1c, and 1d.

FIG. 1b is a block diagram of a conventional audio system.

FIG. 1c is flow diagram illustrating the complexities of a parametric audio system, and defining the terminology of a parametric audio system.

FIG. 1d is an alteration of FIG. 1c, with specific applications to the present invention.

FIG. 2 is an illustration of a conventional surround sound system.

FIG. 3a is an illustration of a sound source heard by a listener.

FIG. 3b is an illustration of a conventional audio system's attempt to reproduce the sound source of FIG. 3a.

FIG. 3c is an illustration of a prior art method for eliminating cross-talk between the output of conventional speakers.

FIG. 4 is an illustration of conventional headphones.

FIG. 5 is an illustration of a virtual headset providing isolated detection of sound at one ear, in accordance with one embodiment of the invention.

FIG. 6 is an illustration of a virtual headset providing acoustic differentiation of amplitudes of sound arriving at two ears, in accordance with one embodiment of the invention.

FIG. 7 is an illustration of an electro-acoustical emitter that is capable of phase controlling the propagated wave, in accordance with one embodiment of the invention.

FIG. 8 is an illustration of an electro-acoustical emitter that is capable of emitting multiple propagated waves that may be heard differentially at the ears of multiple listeners.

FIG. 9a is an illustration of a parametric loudspeaker system using two electro-acoustical emitters and providing acoustically differentiable sound to a listener, in accordance with one embodiment of the invention.

FIG. 9b is an illustration of a parametric loudspeaker system using two electro-acoustical emitters and providing acoustically differentiable sound to a listener, in accordance with another embodiment of the invention.

FIG. 10 is an illustration of an electro-acoustical emitter that is capable of focusing an emitted wave to a relatively small area.

FIG. 11 is an illustration of a parametric loudspeaker system using two electro-acoustical emitters and providing acoustically differentiable sound to a listener, in accordance with another embodiment of the invention.

FIG. 12 is an illustration of a parametric loudspeaker system that is capable of directing an emitted wave towards a moving target element, by phase controlling the emitted wave.

FIG. 13 is an illustration of a parametric loudspeaker system that is capable of directing multiple emitted waves towards multiple moving target elements, by phase controlling the emitted wave.

FIG. 14a and 14b are illustrations of a parametric loudspeaker system that is capable of directing an emitted wave towards a moving target element, by adjusting the emission surface of the emitter.

FIG. 15a and 15b are illustrations of a parametric loudspeaker system that is capable of directing multiple emitted waves towards multiple moving target elements, by adjusting the emission surfaces of two emitters.

FIG. 16 is an illustration of a parametric loudspeaker system that employs two electro-acoustical emitters, each capable of phase directing an emitted wave towards a moving target element.

FIG. 17 is a flow diagram of a method for generating localized sound at a listening location having coordinated first and second reception points.

FIG. 18 is a flow diagram of a method for enabling binaural listening to audio material by a listener without need for earphones or other physical audio producing devices attached to the listener, the method comprising FIG. 19 is a flow diagram of a method for minimizing cross-talk between output waves of at least a first and a second loudspeaker.

FIG. 20 is a flow diagram of another method for minimizing cross-talk between output waves of at least a first and a second loudspeaker.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

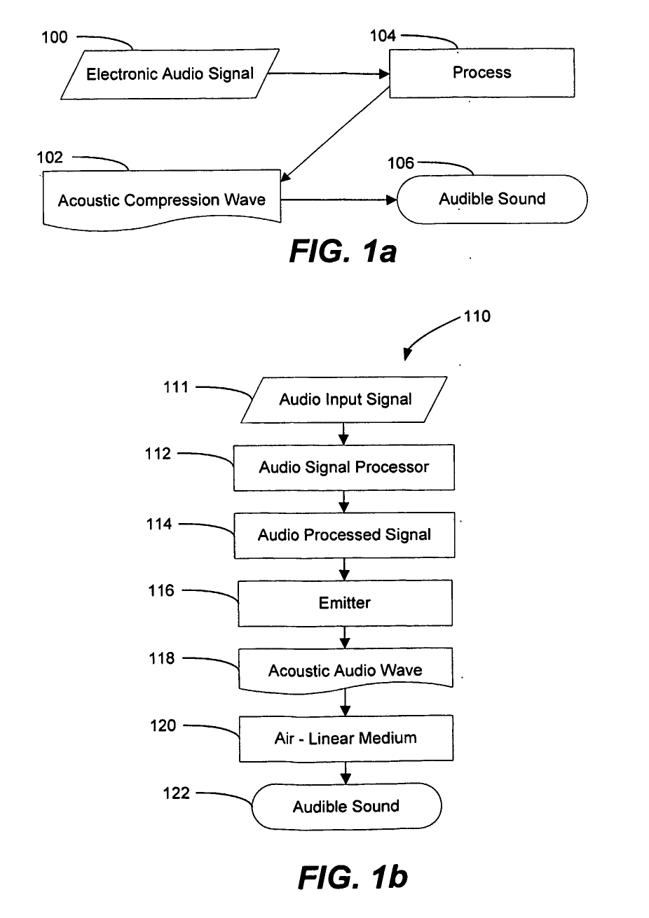

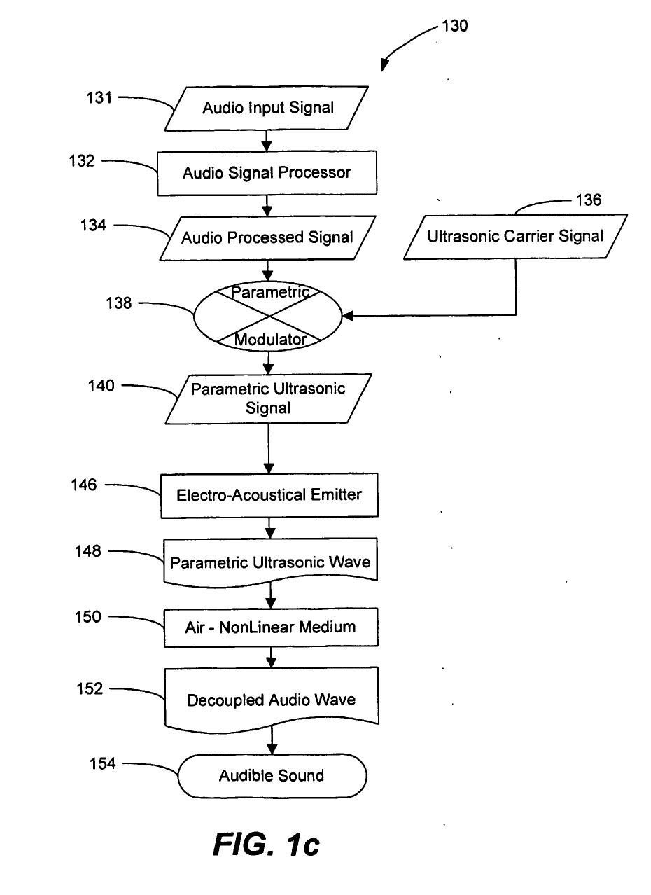

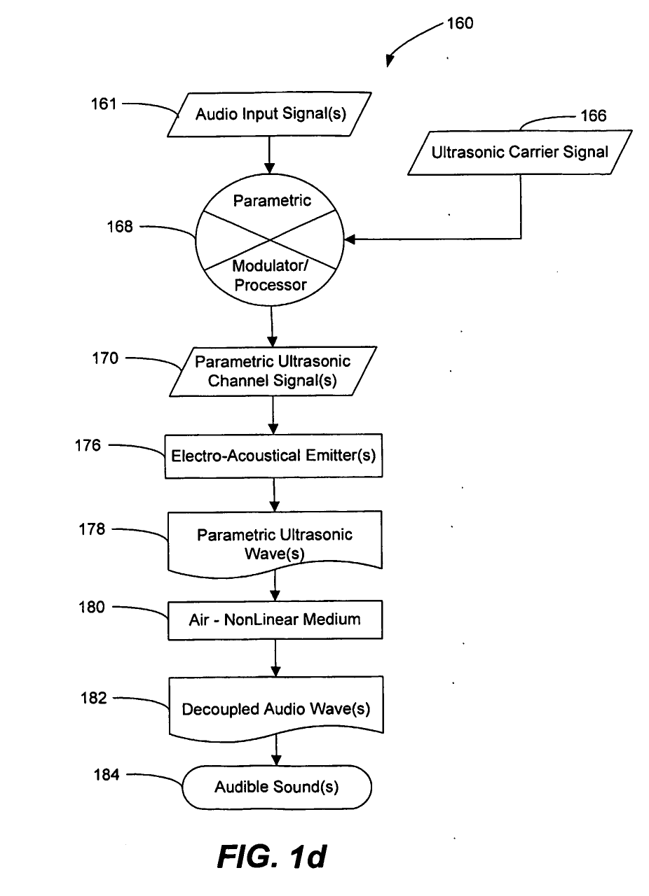

Because parametric sound is a relatively new and developing field, and in order to identify the distinctions between parametric sound and conventional audio systems, the following definitions, along with the explanatory diagrams of FIGS. 1a, 1b and 1c are provided. While the following definitions may also be employed in future applications from the present inventor, the definitions are not meant to retroactively narrow or define past applications or patents from the present inventor or his assignee.

FIG. 1a serves the purpose of establishing the meanings that will be attached to various block diagram shapes in FIGS. 1b and 1c. The block labeled 100 will represent any electronic audio signal. Block 100 will be used whether the audio signal corresponds to a sonic signal, an ultrasonic signal, or a parametric ultrasonic signal. Throughout this application, any time the word ‘signal’ is used, it refers to an electronic representation of an audio component, as opposed to an acoustic compression wave.

The block labeled 102 will represent any acoustic compression wave. As opposed to an audio signal, which is in electronic form, an acoustic compression wave is propagated into the air. The block 102 representing acoustic compression waves will be used whether the compression wave corresponds to a sonic wave, an ultrasonic wave, or a parametric ultrasonic wave. Throughout this application, any time the word ‘wave’ is used, it refers to an acoustic compression wave which is propagated into the air.

The block labeled 104 will represent any process that changes or affects the audio signal or wave passing through the process. The audio passing through the process may either be an electronic audio signal or an acoustic compression wave. The process may either be a manufactured process, such as a signal processor or an emitter, or a natural process such as parametric sound generation using an air medium.

The block labeled 106 will represent the actual audible sound that results from an acoustic compression wave. Examples of audible sound may be the sound heard in the ear of a user, or the sound sensed by a microphone.

FIG. 1b is a flow diagram 110 of a conventional audio system. In a conventional audio system, an audio input signal 111 is supplied which is an electronic representation of the audio wave being reproduced. The audio input signal 111 may optionally pass through an audio signal processor 112. The audio signal processor is usually limited to linear processing, such as the amplification of certain frequencies and attenuation of others. Very rarely, the audio signal processor 112 may apply non-linear processing to the audio input signal 111 in order to adjust for non-linear distortion that may be directly introduced by the emitter 116. If the audio signal processor 112 is used, it produces an audio processed signal 114.

The audio processed signal 114 or the audio input signal 111 (if the audio signal processor 112 is not used) is then emitted from the emitter 116. As discussed in the section labeled ‘related art’, conventional sound systems typically employ dynamic speakers as their emitter source. Dynamic speakers are typically comprised of a simple combination of a magnet, voice coil and cone. The magnet and voice coil convert the variable voltage of the audio processed signal 114 to mechanical displacement, representing a first stage within the dynamic speaker as a conventional multistage transducer. The attached cone provides a second stage of impedance matching between the electrical transducer and air envelope surrounding the emitter 116, enabling transmission of small vibrations of the voice coil to emerge as expansive acoustic audio wave 118. The acoustic audio wave 118 proceeds to travel through the air 120, with the air substantially serving as a linear medium. Finally, the acoustic audio wave reaches the ear of a listener, who hears audible sound 122.

FIG. 1c is a flow diagram 130 that clearly highlights the complexity of a parametric sound system as compared to the conventional audio system of FIG. 1b. The parametric sound system also begins with an audio input signal 131. The audio input signal 131 may optionally pass through an audio signal processor 132. The audio signal processor in a parametric system commonly performs both linear and non-linear processing. It is known to practitioners of the parametric loudspeaker art that low frequencies of the audio input signal 131 will eventually be reproduced at a reduced level compared to the higher audio frequencies. This reduction in low frequency output causes a substantially 12 dB per octave slope with decreasing audio frequencies. It is well known to invoke linear pre-equalization to the audio input signal to compensate for this attribute of parametric loudspeakers. It is also known to perform nonlinear processing in the audio signal processor 132 such as a square rooting technique, where the audio input signal 131 is square rooted to compensate for the squaring effect that occurs as a parametric ultrasonic wave 148 (described in detail below) decouples in air 150 to form a decoupled audio wave 152. If the audio signal processor 132 is used, it produces an audio processed signal 134.

The audio processed signal 134 or the audio input signal 131 (if the audio signal processor 132 is not used) is then parametrically modulated with an ultrasonic carrier signal 136 using a parametric modulator 138. The ultrasonic carrier signal 136 may be supplied by any ultrasonic signal source. While the ultrasonic carrier signal 136 is normally fixed at a constant ultrasonic frequency, it is possible to have an ultrasonic carrier signal that varies in frequency. The parametric modulator 138 is configured to produce a parametric ultrasonic signal 140, which is comprised of an ultrasonic carrier signal, which is normally fixed at a constant frequency, and at least one sideband signal, wherein the sideband signal frequencies vary such that the difference between the sideband signal frequencies and the ultrasonic carrier signal frequency are the same frequency as the audio input signal 131. The parametric modulator 138 may be configured to produce a parametric ultrasonic signal 140 that either contains one sideband signal (single sideband modulation, or SSB), or both upper and lower sidebands (double sideband modulation, or DSB).

Normally, the parametric ultrasonic signal 140 is then emitted from the emitter 146, producing a parametric ultrasonic wave 148 which is propagated into the air 150. The parametric ultrasonic wave 148 is comprised of an ultrasonic carrier wave and at least one sideband wave. The parametric ultrasonic wave 148 drives the air into a substantially non-linear state. Because the air serves as a non-linear medium, acoustic heterodyning occurs on the parametric ultrasonic wave 148, causing the ultrasonic carrier wave and the at least one sideband wave to decouple in air, producing a decoupled audio wave 152 whose frequency is the difference between the ultrasonic carrier wave frequency and the sideband wave frequencies. Finally, the decoupled audio wave 152 reaches the ear of a listener, who hears audible sound 154. The end goal of parametric audio systems is for the decoupled audio wave 152 to closely correspond to the original audio input signal 131, such that the audible sound 154 is ‘pure sound’, or the exact representation of the audio input signal.

FIG. 1d is an alteration of FIG. 1c, as it applies to the present invention. To realize the invention, it may be required to provide multiple decoupled audio waves 554. Many of the following examples will reference FIG. 1d to clearly explain the various embodiments of the invention.

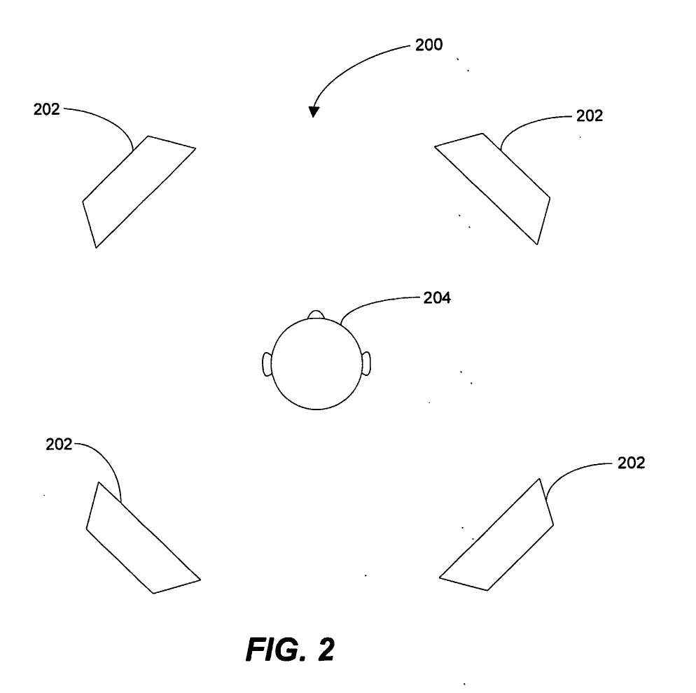

FIG. 2 illustrates an example of a conventional surround sound system 200 having four or more speakers 202 placed around the listener 204. The volumes and phase differentials of the compression waves being emitted from each speaker may be adjusted to enable the listener 204 to perceive a sense of direction of detected sounds. The multiple speaker locations may place undesirable demands on the aesthetics of the domestic environment, as well as increase the complexity of system installation. Further, there is often a situation where the ideal location for a particular speaker channel is not available, particularly for the surround channels, which often must be hung on rear or sidewalls, ideally in a symmetrical fashion about the listener.

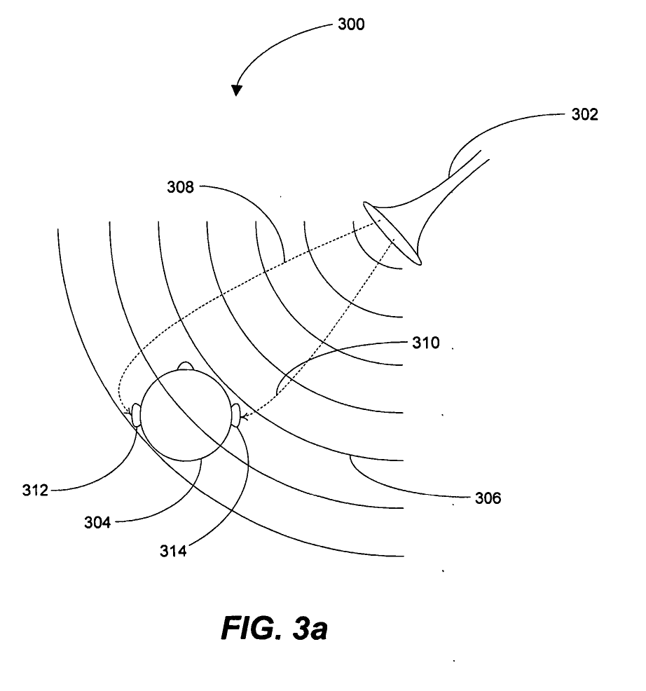

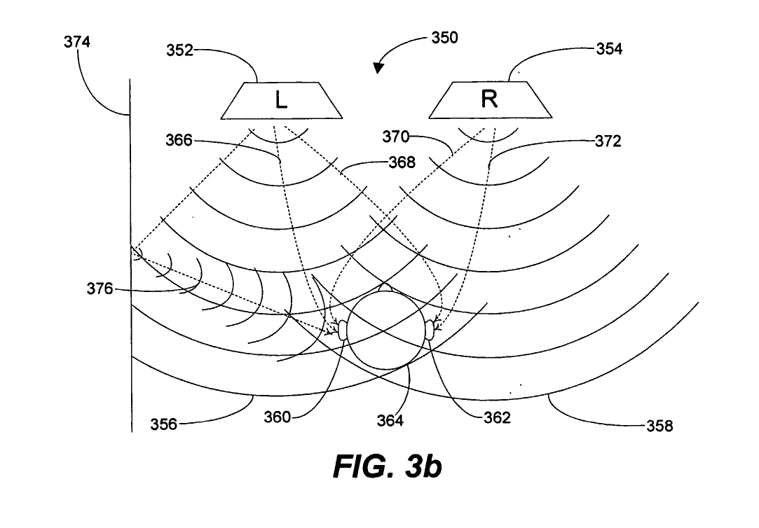

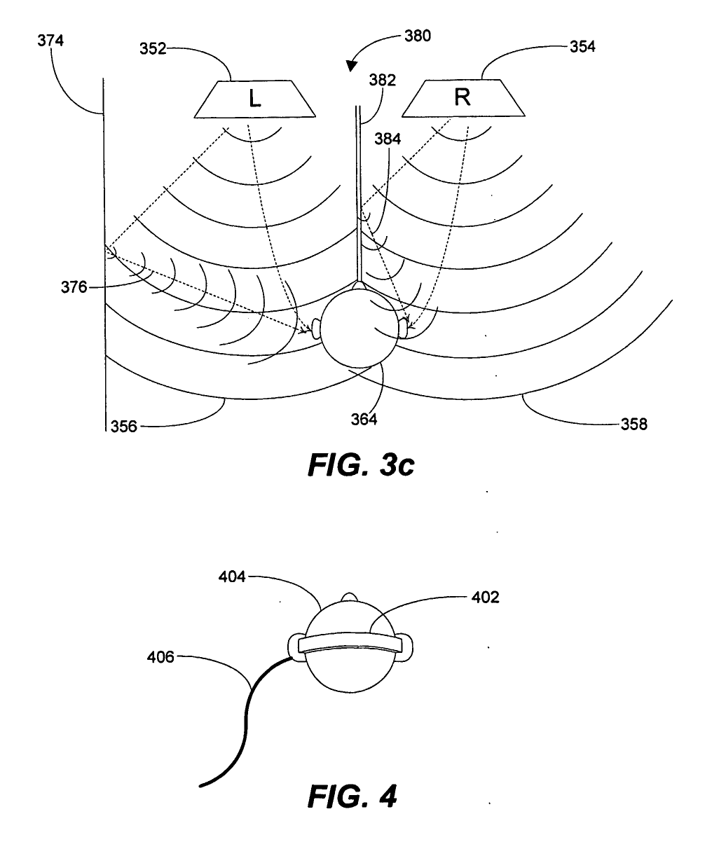

In addition to undesirable aesthetic effects, it is very difficult to perfectly reproduce a virtual sound source using multiple conventional speakers. FIG. 3a is a simple illustration of how a listener 304 would normally sense the direction of an actual sound source 302. The sound source 302 produces a compression wave 306 in a substantially omnidirectional pattern. The arrows 308 and 310 roughly represent the path of the sound as it travels from the sound source to the ears 312 and 314 of the listener 304. Humans possess the ability to detect subtle phase delays as a sound arrives at one ear slightly before the other ear. This phase difference enables humans to determine the physical location of a sound source. This sense of direction may occur even when the amplitudes of the waves arriving at each ear are substantially the same. In the example of FIG. 3a, the sound arrives at the right ear 314 slightly before the left ear 312. This phase differential allows the listener to determine that the sound source originated slightly to his right.

FIG. 3b illustrates a simple attempt to employ conventional loudspeakers 350 to reproduce sound. In this simple example, left 352 and right 354 speakers are provided. To reproduce the sound source shown 302 in FIG. 3a, the amplitude of the wave 358 emitted from the right speaker 354 may be slightly greater than the amplitude of the wave 356 emitted from the left speaker 352. In more complex system, a phase differential may also be introduced between the right 354 and left 352 speakers to generate the effect that the sound arriving at the left ear 360 is phase delayed as compared to the right ear 362. However, because conventional speakers produce substantially omnidirectional speakers, it is nearly impossible to produce a compression wave with the left speaker that is not heard by both the right and left ears. Consequently, a listener 364 can easily become confused as to the location of the virtual sound source. This inevitable crosstalk is illustrated by the arrows 366, 368, 370 and 372, which roughly represent the sound path from the speakers 352 and 354 to the ears 360 and 362 of the listener 364. Crosstalk between the speakers 352 and 354 distorts the waves arriving at the ears of the user such that the sound becomes very two dimensional, and all virtual sound sources will appear to originate somewhere between the left and right speakers.

Elaborate cross-talk cancellation techniques have been used in an attempt to overcome the crosstalk that inevitably exists when multiple conventional speakers are used. Signals are sent by each speaker which are intended to arrive at the ears of the user 180° out of phase with the cross-talk signals in order to cancel their effects. However, because of the omnidirectional nature of conventional speakers, the cancellation wave will inevitably reach both ears, which in turn creates additional cross talk signals which also must be canceled. The perpetual nature of this comb filtering techniques may cause tonal coloration to the sound, causing voices to sound unnatural.

An additional problem is that conventional speakers will inevitably produce reflection waves 376 from side walls 374, ceilings, and floors. The additional waves produced by room interaction interfere with the primary waves 368, 370, 372 and 374, further misrepresenting the location of the virtual sound source. Because of the aforementioned problems, previous attempt to produce true binaural sound using conventional speakers, have had limited commercial or technical success.

Because of the extensive cross-talk cancellation techniques that must be used to approximate true binaural sound with conventional speakers, the most effective prior art method for controlling crosstalk is illustrated in FIG. 3c, where a dividing structure 382 is extended from the nose of the user 364 such that the waves 356 and 358 from the two speakers 352 and 354 are completely isolated. While this technique has produced impressive results, the problem of reflected waves 376 and 384 still exist. The obvious problem with this technique is that it is hardly a commercially acceptable solution.

Thus far, the only practical method for eliminating the crosstalk described above has been for the listener to wear headphones, which isolate the sound heard by each ear. Impressive results can be achieved by listening to a binaural recording through headphones, which employ various phase and volume control techniques to accurately enable the listener to pinpoint the virtual sound source. Unfortunately, as shown in FIG. 4, headphones 402 require the listener 404 to wear an often bulky apparatus on his or her head, and usually require the listener to be connected to the signal source by a wire or cable 406. Furthermore, headphones may mistune the ear canal, thereby creating tonal irregularities.

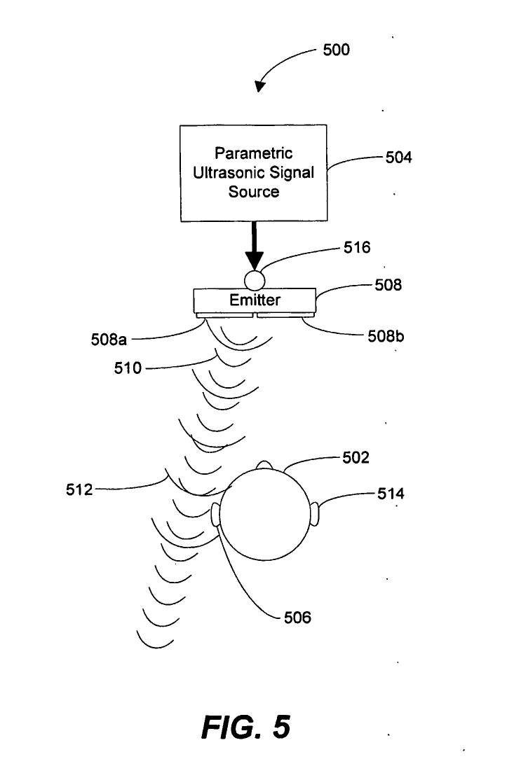

As illustrated in FIG. 5, and in accordance with one embodiment of the present invention, a virtual headset 500 is disclosed which offers the benefits provided by conventional headphones, without need for earphones or other physical audio producing devices attached to the listener 502. The embodiment of FIG. 5 includes a parametric ultrasonic signal source 504, which corresponds to the output signal as sourced by the parametric modulator/processor 168 of FIG. 1d. The processor is an optional part of, or an addition to the modulator, depending on the required complexity of its output. The signal source 504 supplies at least a first parametric ultrasonic channel signal comprised of an ultrasonic carrier signal and at least one sideband. The parametric ultrasonic channel signal is represented in FIG. 1d as block 170. The first parametric ultrasonic channel is configurable to be primarily directed at a first ear 506 of the listener 502. The signal source 504 is coupled to an electro-acoustical emitter structure 508. The electro-acoustical emitter structure 508 is configured to emit and direct a first parametric ultrasonic wave 510 corresponding to the first parametric ultrasonic channel signal along a first orientation such that a first resultant decoupled audio wave 512 will be dominantly heard at the first ear 506 of the listener 502, with reduced audible sound detection at a second ear 514 of the listener 502. The virtual headset 500 may also include a support structure 516 coupled to the electro-acoustical emitter structure 508 and configured to provide directional orientation of the parametric ultrasonic wave 510 exclusively to the listener 502.

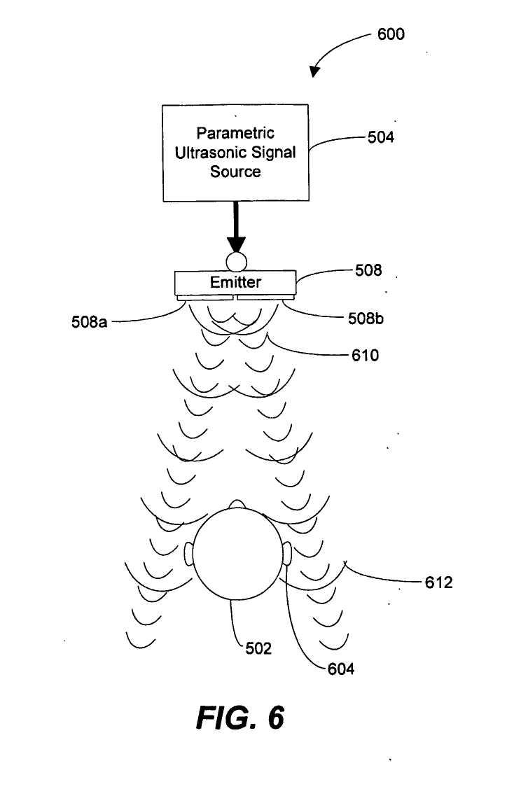

In another embodiment, as illustrated in FIG. 6, the parametric ultrasonic signal source 504 may also supply a second parametric ultrasonic channel signal also comprised of an ultrasonic carrier signal and at least one sideband. As shown in FIG. 1d, multiple ultrasonic parametric channel signals 170 may be supplied by the parametric modulator/processor 168. The second parametric ultrasonic channel signal may be configured to be predominately directed at the second ear 604 of the listener 502. The electro-acoustical emitter 508 may emit a corresponding second parametric ultrasonic wave 610 such that a second resultant decoupled audio wave 612 will be dominantly heard at the second ear 604 of the listener 502, with reduced audible sound detection at the first ear 614 of the listener 502. As a result, acoustic differentiation of amplitudes arriving at each ear is thereby enabled.

In the context of the present invention, “acoustic differentiation of amplitudes” signifies that if a wave is intended to be heard at a first ear of a listener, it will either be undetected by the second ear, or will be detected by the second ear at a significantly lower amplitude than at the first ear. When acoustic differentiation of amplitudes is realized, many benefits can be attained, such as true binaural sound production. As described above, acoustic differentiation of amplitudes arriving at each ear of the listener has been impractical using conventional speakers. However, because of the directional nature of parametric loudspeakers, it is possible to emit one parametric ultrasonic wave that is detectable by the first ear of a listener, and substantially undetectable at the second ear. Likewise, a second parametric ultrasonic wave may be emitted that is detectable by the second ear of the listener, and substantially undetectable at the first ear. Therefore, acoustic differentiation of amplitudes arriving at each ear of the listener is enabled.

To attain acoustic differentiation of amplitudes arriving at each ear, it may be beneficial that the first decoupled audio wave is arrive at the first ear at an acoustic level of at least six dB greater than at the second ear, and the second decoupled audio wave arrive at the second ear at an acoustic level of at least six dB greater than at the first ear. When a six dB difference exists between the acoustic levels arriving at each ear of a listener, the listener obtains a substantial sense of acoustic differentiation of amplitudes.

In another embodiment, the first decoupled audio wave is configured to arrive at the first ear at an acoustic level of at least fifteen dB greater than at the second ear, and the second decoupled audio wave is configured to arrive at the second ear at an acoustic level of at least fifteen dB greater than at the first ear. When a fifteen dB difference exists between the acoustic levels arriving at each ear of a listener, the listener effectively obtains a sense of full acoustic differentiation of amplitudes.

In one embodiment of the system of FIG. 6, instead of directing the first and second parametric ultrasonic waves towards the first and second ears of a listener, the waves may be directed towards coordinated first and second reception points within a listening location. For example, the first and second reception points may be two microphones positioned within the listening location. The listening location may be comprised of a three-dimensional volume, no larger than five foot by five foot by five foot in size, wherein the first and second reception points are located. Because of the directional nature of parametric speakers, independent propagated sound waves may be delivered to each reception point with little or no cross talk, thus enabling acoustic differentiation of amplitudes at the reception points within the listening location. Alternatively, the listening location may be comprised of a personal space for an individual listener, as portrayed in FIGS. 5 and 6. In another embodiment, the listening location is comprised of the approximate environment surrounding a chair, where a listener may be situated.

In one embodiment of the virtual headset employing more than one channel, the second parametric ultrasonic channel signal is identical to the first. If such is the case, only one audio input signal 161 (FIG. 1d) is usually required, and the processor 168 may configure the modulated signal so that multiple parametric ultrasonic waves will be directed towards separate target elements, such as the first and second ears of the listener. In another embodiment, the second parametric ultrasonic channel signal is distinct from the first. For example, the first and second parametric ultrasonic channel signals may contain left and right audio channel information. In such a case, multiple audio input signals 161 are required, containing left and right audio channel information. The processor 168 may configure the modulated signals such that the audio input signals will be converted into unique parametric ultrasonic channel signals 170 that may be individually directed towards separate target elements such as the first and second ears of the listener.

The parametric ultrasonic emitter structure may include a piezoelectric film configured for emitting parametric ultrasonic waves. The present inventors have previously discovered and disclosed that a piezoelectric film is an ideal material for emitting parametric ultrasonic waves. Various types of film may be used as the emitter film. The important criteria are that the film be capable of responding to an applied electrical signal to constrict and extend in a manner that reproduces an acoustic output corresponding to the signal content. Although piezoelectric materials are the primary materials that supply these design elements, new polymers are being developed that are technically not piezoelectric in nature. Nevertheless, the polymers are electrically sensitive and mechanically responsive in a manner similar to the traditional piezoelectric compositions. Accordingly, it should be understood that reference to piezoelectric films in this application is intended to extend to any suitable film that is both electrically sensitive and mechanically responsive (ESMR) so that acoustic waves can be realized in the subject transducer.

The virtual headset may be configured to perform differential phase controlling of the propagated wave at an emission surface of the electro-acoustical emitter such that the orientation of the propagated wave may be controlled. To simplify the explanation of phase controlling of the propagated wave, an example is provided involving only a single channel and corresponding ultrasonic wave. To enable phase controlling of the propagated wave, the emission surface of the electro-acoustical emitter 508 structure may be divided into multiple isolated emitting portions 508a. Each isolated emitting portion is driven by the parametric ultrasonic signal source, wherein at least one isolated emitting portion is driven with a signal having a phase differential as compared to the other isolated emitting portions. The amount of phase differential causes the orientation of the resultant parametric wave to be beam steered, or directed towards a desired location. As illustrated in FIG. 5, the desired location may be the ear 506 of a listener 502.

The phase controlling technique described above may also be employed where more than one parametric ultrasonic wave is emitted from a single emitter, as shown in FIG. 6. The parametric ultrasonic emitter 508 includes multiple isolated emitting portions 508a. Each isolated emitting portion is driven by a parametric ultrasonic signal source, which includes superimposed first and second parametric ultrasonic channel signals intended to be heard predominately at the first and second ears of the listener. The first and second channel signals applied to one isolated emitting portion have a phase differential as compared to the first and second channel signals applied to other isolated emitting portions. The first and second parametric ultrasonic waves, corresponding to the first and second channel signals are emitted from the electro-acoustical emitter simultaneously, and because a phase differential exists between the multiple isolated emitting portions, the orientation of the first and second parametric ultrasonic waves can be directed independently of one another. The above technique enables a single emitter structure to direct the first parametric ultrasonic wave containing the first channel signal information substantially exclusively to the first ear of the listener, and the second parametric ultrasonic wave containing the second channel information substantially exclusively to the second ear of the listener.

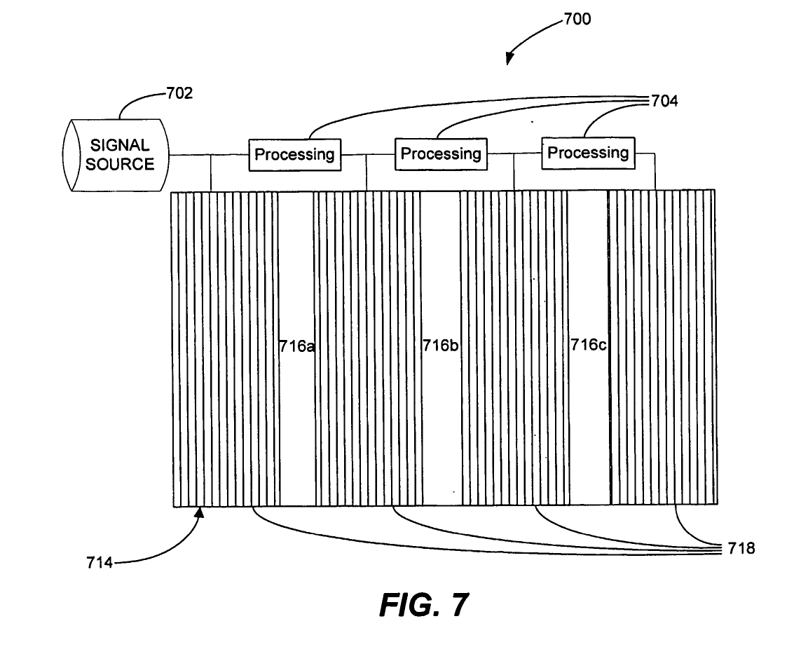

FIG. 7 illustrates an ESMR film emitter 714 configured to perform the above phase delay technique. The film 714 is divided into multiple electrically isolated conductive portions 718 by etching away separating strips 716. The conductive portions 718 correspond to the isolated emitting portions 508a in FIGS. 5 and 6. In one embodiment, only the conductive portion of the separating strips 716 has been etched away, so that the emitter film 714 is still one continuous, uniform piece of film. Each of the electrically isolated portions 718 of film may be driven by a signal that has been delayed by differing amounts. The processors 704 may consist of simple delays, with individual amplifiers. Instead of connecting the processors 704 in series, as shown in FIG. 7, they may be connected in parallel, each performing independent control on the signal. By phase delaying the parametric signal applied to one piece of film more than the parametric signals applied to other pieces of film, a phase differential between the pieces of film is created, and the emitted parametric ultrasonic wave can be steered in various directions. While FIG. 7 only shows a one-by-four array of electrically isolated conductive portions 718, smaller or larger arrays can be formed that allow precise phase control of the propagated wave at the emission surface, thus allowing for precise directivity of the wave front, and enabling the ability to propagate multiple parametric ultrasonic waves from the emission surface. The delay circuits may also be switchable so that the delay can be turned off, creating an emitter surface that does not control phase of the propagated wave at the emission surface. Finally, it should be appreciated that FIG. 7 is only one possible way to create an emitter that is capable of implementing the phase delay technique. Many types of emitters may be capable of implement the present invention.

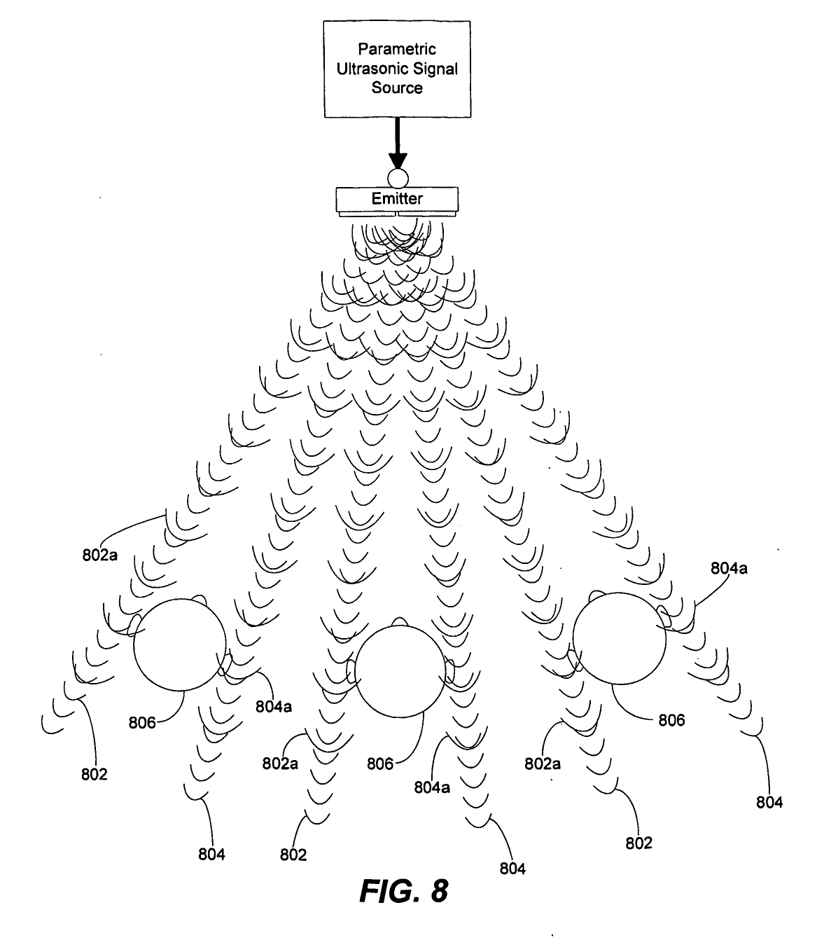

FIG. 8 illustrates an embodiment where the phase delay techniques described above are employed to direct first 802 and second 804 parametric ultrasonic waves at the first and second ears of more than one listener 806. Each of the parametric ultrasonic waves 802 and 804 generate a corresponding decoupled audio wave 802a and 804a. For each parametric ultrasonic wave propagated from the emission surface, there is also a corresponding parametric ultrasonic channel signal driving the various isolated emitting portions. In order to steer a parametric ultrasonic wave in a desired direction, the corresponding channel signal is applied to each isolated emitting portion at a phase differential as compared to the other isolated emitting portion. All of the channel signals applied to each isolated emitting portion are superimposed, and emitted simultaneously. When the emitted parametric ultrasonic waves leave the emission surface 808, the phase differentials existing between the waves emitted from each isolated emitting portion cause each parametric ultrasonic wave to be oriented in a desired direction.

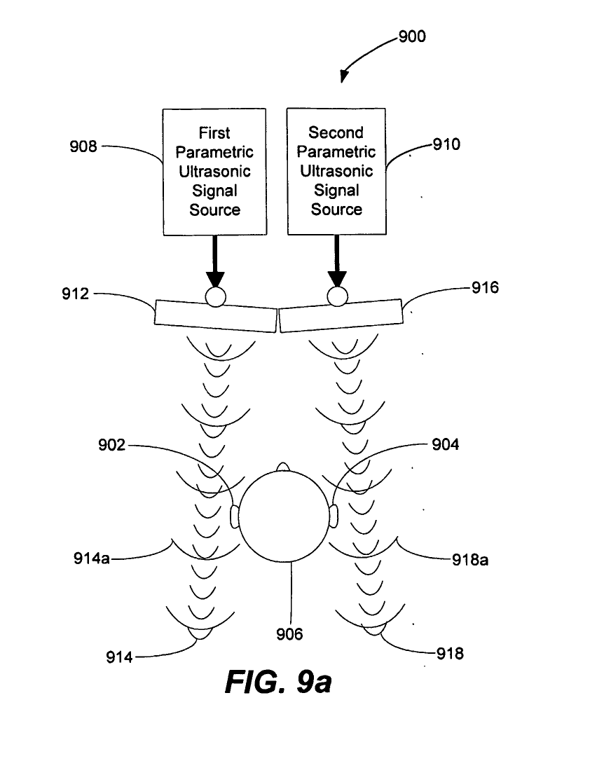

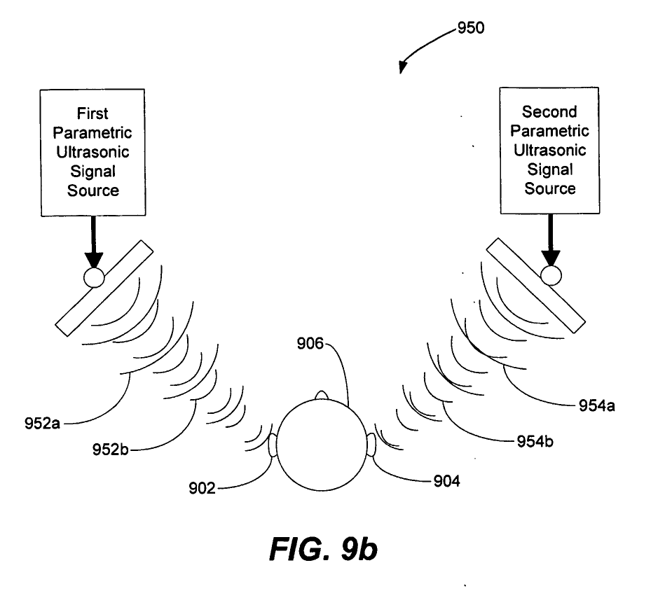

FIG. 9a illustrates another embodiment of the invention, comprising a parametric loudspeaker system 900 for enabling isolated listening to audio material at a first 902 and a second 904 ear of a listener 906. A first parametric ultrasonic signal source 908 supplies a first parametric ultrasonic channel signal having an ultrasonic carrier signal and at least one sideband. The first parametric ultrasonic channel signal is configured to be emitted and directed substantially exclusively at the first ear 902 of the listener 906. A second parametric ultrasonic signal source 910 supplies a second parametric ultrasonic channel signal having an ultrasonic carrier signal and at least one sideband. The second parametric ultrasonic channel signal is configured to be emitted and directed substantially exclusively at the second ear 904 of the listener 906. A first electro-acoustical emitter 912 is coupled to the first parametric ultrasonic signal source 908, and is capable of orienting a first parametric ultrasonic wave 914 corresponding to the first channel signal at the first ear 902, wherein a resultant first decoupled audio wave 914a is detected by the first ear 902 at an acoustic level substantially greater than at the second ear 904. A second parametric ultrasonic emitter 916 is coupled to the second parametric ultrasonic signal source 910, and is capable of orienting a second parametric ultrasonic wave 918 corresponding to the second channel signal for detection at the second ear 904, wherein a resultant second decoupled audio wave 918a is detected by the second ear 904 at an acoustic level substantial greater than at the first ear 902. As a result, acoustic differentiation of amplitudes arriving at each ear is thereby enabled.

Instead of projecting the first and second ultrasonic waves past the user, as illustrated in FIG. 9a, the parametric loudspeaker system 950 may be configured to focus the first 952b and second 954b parametric ultrasonic waves to a point at or near the ears 902 and 904 of the listener 906, as illustrated in FIG. 9b. By focusing a wave at a point at or near the first ear 902 of the listener 906, little, if any of the audible sound from the resultant first decoupled audio wave 952a can be heard at the second ear 904 of the listener 906.

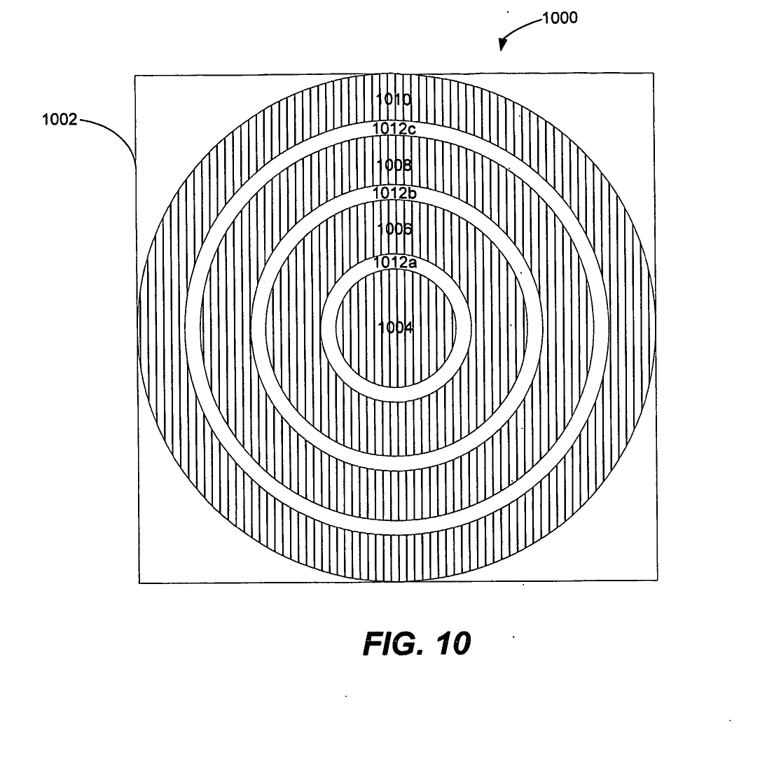

FIG. 10 illustrates one means for focusing the parametric ultrasonic waves at the ears of the listener. An ESMR film 1002 is provided, where at least one ring section 1012a, 1012b or 1012c of the electrically conductive portion of the ESMR film is etched away. The etching forms at least a center circular conductive portion 1004 of film, and at least one outer ring portion of conductive film 1006, 1008, and 1010. Each conductive portion 1004, 1006, 1008, and 1010 of film is electrically isolated. The etched ring portions 1012 of film are formed as narrow as possible while avoiding electrical arcing between the conductive portions 1004, 1006, 1008, and 1010 of film. The width of the etched portions 1012 may typically be one-sixteenth of an inch. The phases of the isolated conductive portions 1004 and 1008 may be set to zero degrees, and the phases of the parametric signals driving the isolated conductive portions 1006 and 1010 may be shifted by 180 degrees. Thus, the sound beam propagated from the film can be manipulated to converge to a specific point in space.

In another embodiment of FIG. 10, the conductive portions 1006, 1008, and 1010 may be sized such that their propagated waves will arrive at a designated point in space within a +/−45° phase change. The central conductive portion 1004 may be sized such that its propagated wave will arrive at the same designated point in space within a +/−90° phase change. The diameters of each conductive ring portion of film will depend on the carrier wave frequency and the distance of the desired focal point from a front surface of the transducer.

While FIG. 10 shows only four conductive portions of film, the film may be divided into any number of conductive portions. The delay circuits used to create the phase differentials may be switchable so that the delay can be turned off, creating an emitter surface that does not control the phase of the propagated wave at the emission surface.

An example of a focusing parametric transducer as described in FIG. 10 will now be provided. This example transducer is designed to create a focal point at 36 inches from the front surface of the transducer, using a carrier frequency of 46 kHz. The ESMR film is mounted on a 14″ square support member. The conductive ring portions have diameters of 2.3″ (inner circle), 4″, 5.16″, 6.1″, 6.9″, and 7.68″. The signals applied to each successive ring may differ in phase by 45°, 90°, or 180°.

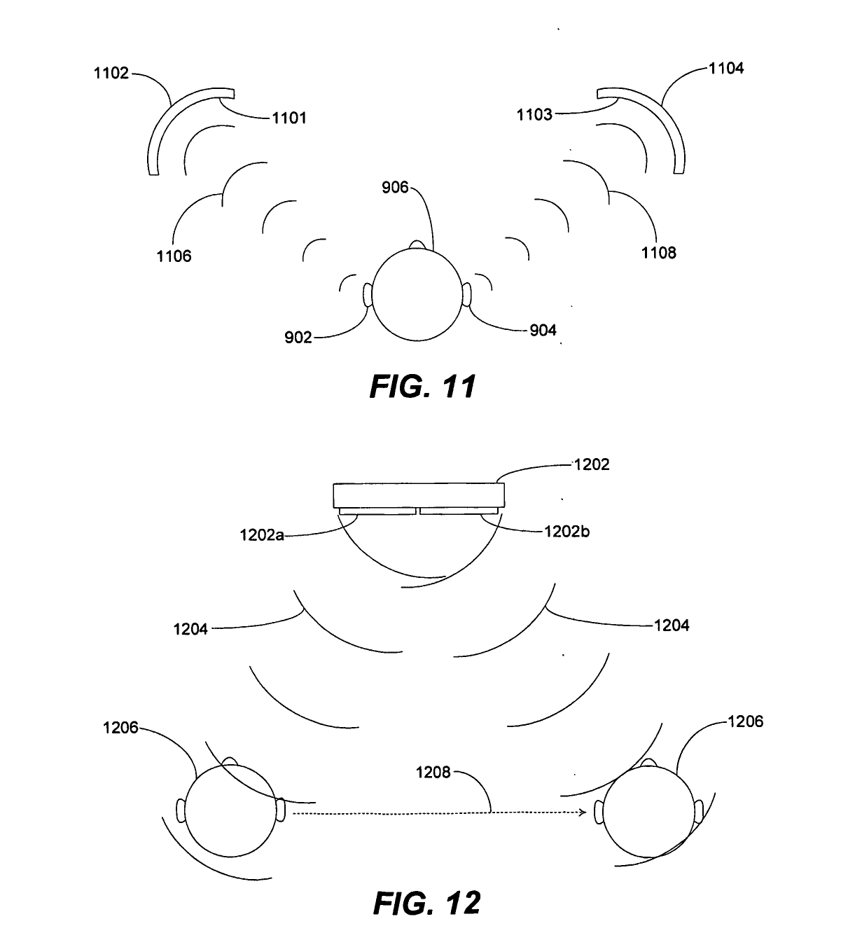

FIG. 11 illustrates another means for focusing the parametric ultrasonic waves at the ears 902 and 904 of the listener 906. In FIG. 11, the emission surfaces 1101 and 1103 of the parametric ultrasonic emitters 1102 and 1104 are configured to have a concave dish curvature. In this embodiment, the waves 1106 and 1108 propagated from the emitters 1102 and 1104 can be focused at a relatively small area, including the ears 902 and 904 of the listener 906. For the sake of simplicity, only one wave is drawn corresponding to each emitter. As a further variation of FIG. 11, the entire emission surface 1101 and 1103 can be formed as a concave bowl, allowing the propagated waves 1106 and 1108 to be focused at a designated point in space.

The above systems are primarily configured for a listener standing or sitting in one predefined location. These embodiments are ideal when the listener is watching a movie or television, sitting at a computer, playing video games; and various other uses that do not require or promote movement by the listener.

However, it may be beneficial to enable a listener to move while using the disclosed invention. For this purpose, the virtual headset may include a tracking circuit coupled to the parametric ultrasonic emitter structure for coordinating movement of a directional orientation of the emitted parametric ultrasonic waves to follow movement of a target element. Typically, the target element is the listener, or a device worn by the listener. A feedback loop may be provided, where the tracking circuit determines the location of the target element, and directs the parametric ultrasonic wave towards the target element in a substantially continuous manner.

Various techniques may be used to enable the emitted parametric ultrasonic waves to follow the target element. First, the phase controlling of the propagated wave may adjust the phase differential of the signals applied to each isolated emitting portion of the emission surface in response to the location of the target element. The changing phase differential will cause the orientation of the emitted parametric ultrasonic waves to follow the target element. For example, FIG. 12 depicts an electro-acoustical emitter 1202 that employs phase controlling of the propagated wave 1204, such that the direction of the propagated wave follows the target element, or the listener 1206, as the listener moves from left to right, indicated by the dotted arrow 1208.

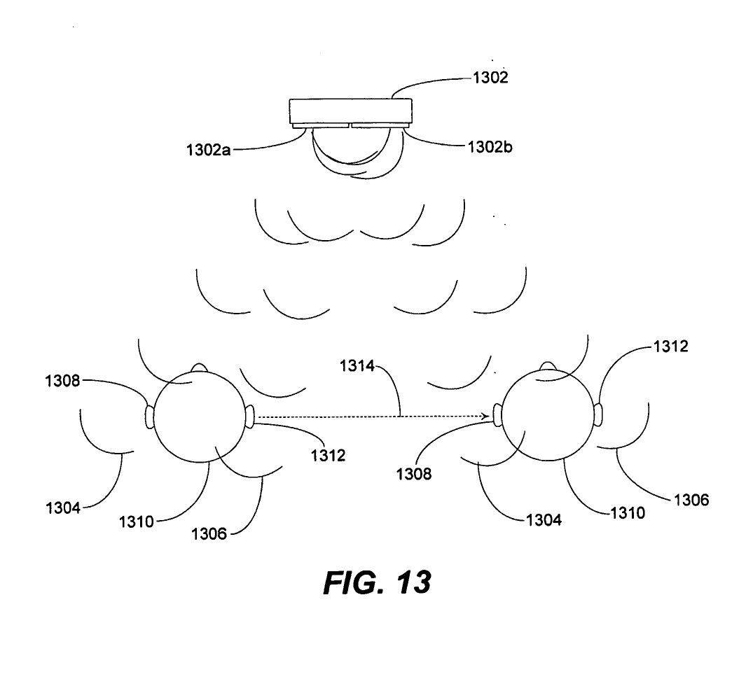

FIG. 13 illustrates a slightly more complex example of an emitter 1302 that employs phase controlling of multiple propagated waves 1304 and 1306. In embodiment shown in FIG. 13, a first parametric ultrasonic wave 1304 is configured to follow the first ear 1308 of the listener 1310, and a second parametric ultrasonic wave 1306 is configured to follow the second ear 1312 of the listener 1310. The technique used for directing the first 1304 and second 1306 parametric ultrasonic waves is similar to that of FIG. 12. However, while the signals applied to the isolated emitting portions of the emitter in FIG. 12 only corresponded to a single channel, the signals applied to the isolated emitting portions of the emitter 1302 in FIG. 13 correspond to two or more channels. The signals corresponding to each individual channel are applied to the isolated emitting portions having a phase differential with respect to one another in order to direct the corresponding emitted parametric ultrasonic wave towards its designated target element. This technique is illustrated in FIG. 13, where the phase differentials of the two parametric ultrasonic channel signals are adjusted in real-time such that the orientations of the two corresponding emitted parametric ultrasonic waves 1304 and 1306 follow the first 1308 and second 1312 ears of the listener 1310 as the listener moves from the left to the right, as indicated by the dotted arrow 1314. The above technique can be expanded such that more than two parametric ultrasonic waves may be emitted, each following a separate target elements. As a result, a single emitter can direct parametric ultrasonic waves to follow the first and second ears of multiple listeners.

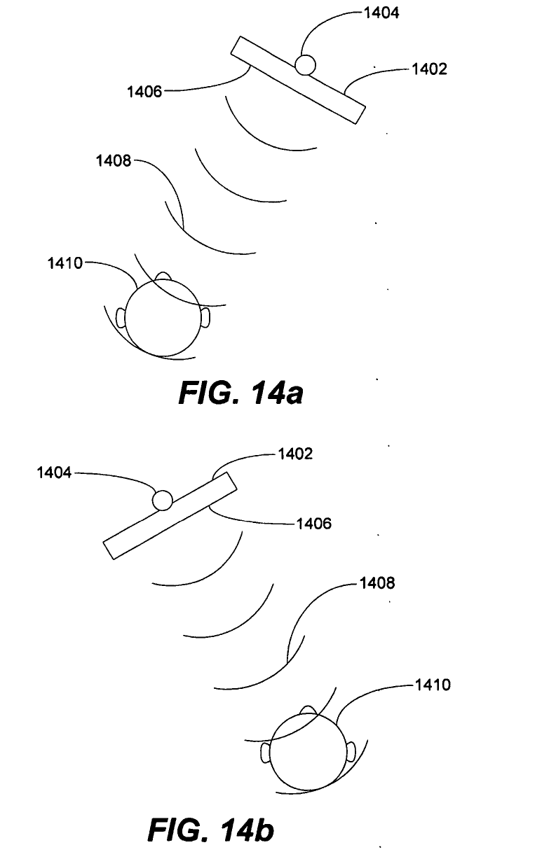

FIGS. 14a and 14b illustrate another technique used to enable the emitted parametric ultrasonic waves to follow the target element. Here, the electro-acoustical emitter 1402 includes a directional support structure 1404 configured to rotate in response to the movement of the target element. Thus, the orientation of the emission surface 1406 of the emitter 1402 will react accordingly, enabling the first parametric ultrasonic wave 1408 to follow movement of the target element. For example, when the listener 1410 moves from the position shown in FIG. 14a to the position of FIG. 14b, the emission surface 1406 changes its orientation so that the emitted parametric ultrasonic wave 1408 follows the listener 1410.

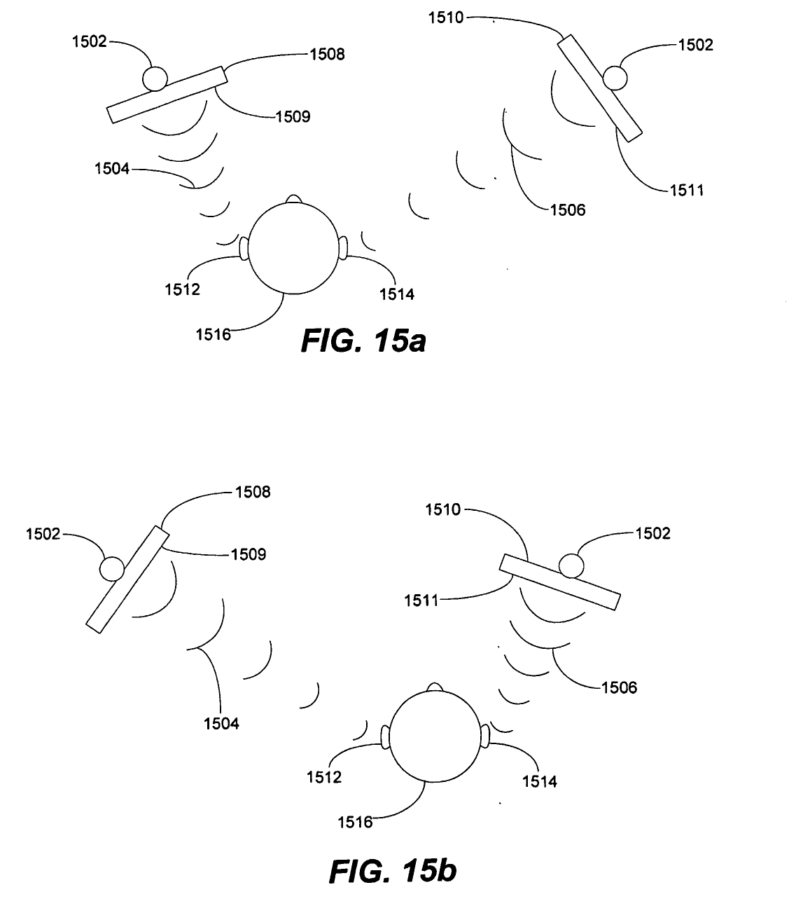

FIGS. 15a and 15b illustrate a slightly more complex example of an emitter structure whose directional supports 1502 rotate to enable the emitted parametric ultrasonic waves 1504 and 1506 to follow the target element. In this example, two electro-acoustical emitters 1508 and 1510 are employed, each having directional support structures 1502 configured to rotate in response to the movement of the target element. Thus, the orientation of the emission surfaces 1509 and 1511 of the first and second electro-acoustical emitters 1508 and 1510 will be adjusted, enabling the first 1504 and second 1506 parametric ultrasonic waves to follow movement of the target element. There may be a separate target element which corresponds to each electro-acoustical emitter. In the present example, the first 1512 and second 1514 ears of a listener 1516 each serve as a target element. As the listener moves from the position shown in FIG. 15a to the position of FIG. 15b, the emission surfaces 1509 and 1511 change their orientation such that the emitted first 1504 and second 1506 parametric ultrasonic waves follow the first 1512 and second 1514 ears of the listener 1516, respectively. Various type of electro-acoustical emitters may be used to implement this system, including, but not limited to the emitters show in FIGS. 10 and 11.

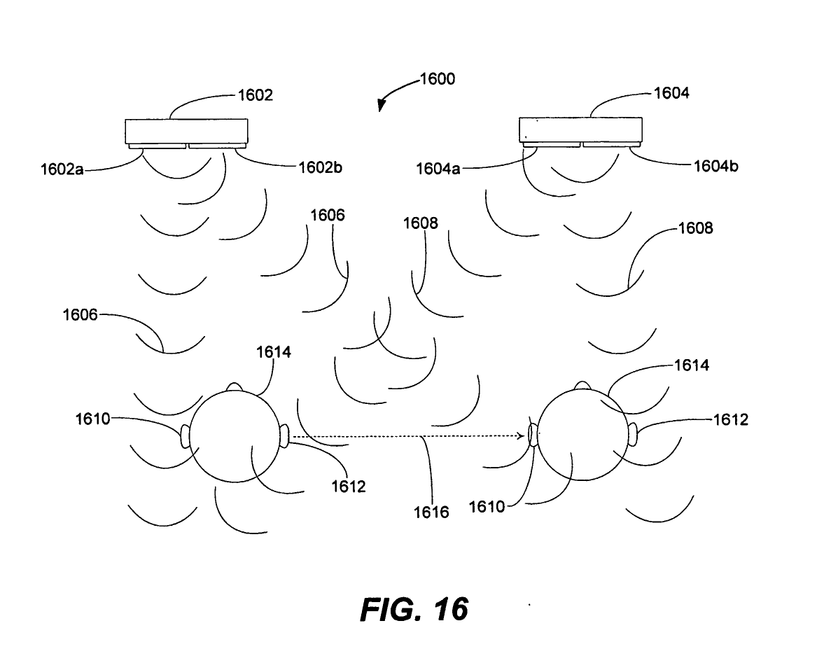

FIG. 16 illustrates an example of a system 1600 having two electro-acoustical emitters 1602 and 1604, each employing phase controlling of their propagated waves 1606 and 1608 as described above. Each electro-acoustical emitter 1602 and 1604 adjusts the orientation of its emitted parametric ultrasonic wave 1606 or 1608 such that it follows a target element, such as an ear 1610 or 1612 of a listener 1614. For example, as the listener 1614 moves from the left to the right, as indicated by the arrow 1616, the emitted parametric ultrasonic waves 1606 and 1608 follow the first 1610 and second 1612 ears of the listener 1614, enabling substantially isolated listening at each ear.

In addition to producing audio, the above systems may also be used to eliminate unwanted noise at the ears of the listener. Traditionally, sound elimination has been difficult when the noise eliminating apparatus has not been placed in close proximity to the ears of the listener. The reason for this difficulty is because conventional loudspeakers were unable to focus a compression wave on the exact region where noise was to be eliminated. Instead, the emitted compression wave containing the noise-eliminating signal was dispersed over a comparatively large region, with only a fraction of the wave arriving at the area where noise was to be eliminated. Because of this difficulty, most effective noise elimination devices have traditionally been headphones, where unwanted noise could be eliminated directly at the ears of the listener. Using the technology disclosed in the present invention, effective noise elimination can be realized without the need of earphones or other physical audio producing devices attached to the listener. By including a noise cancellation circuit, a parametric ultrasonic wave containing noise cancellation information can be emitted from across a room, and can arrive directly at the ears of the user, where noise cancellation is desired.

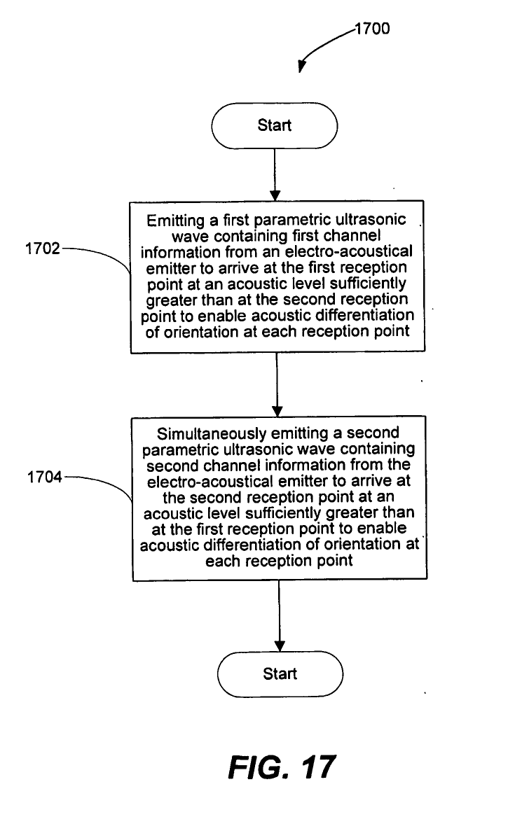

In accordance with FIG. 17, a method 1700 is disclosed for generating localized sound at a listening location having coordinated first and second reception points. The method 1700 may include emitting 1702 a first parametric ultrasonic wave containing first channel information from an electro-acoustical emitter to arrive at the first reception point at an acoustic level sufficiently greater than at the second reception point to enable acoustic differentiation of amplitudes arriving at each reception point. The method 1700 may further include simultaneously emitting 1704 a second parametric ultrasonic wave containing second channel information from the electro-acoustical emitter to arrive at the second reception point at an acoustic level sufficiently greater than at the first reception point to enable acoustic differentiation of amplitudes arriving at each reception point.

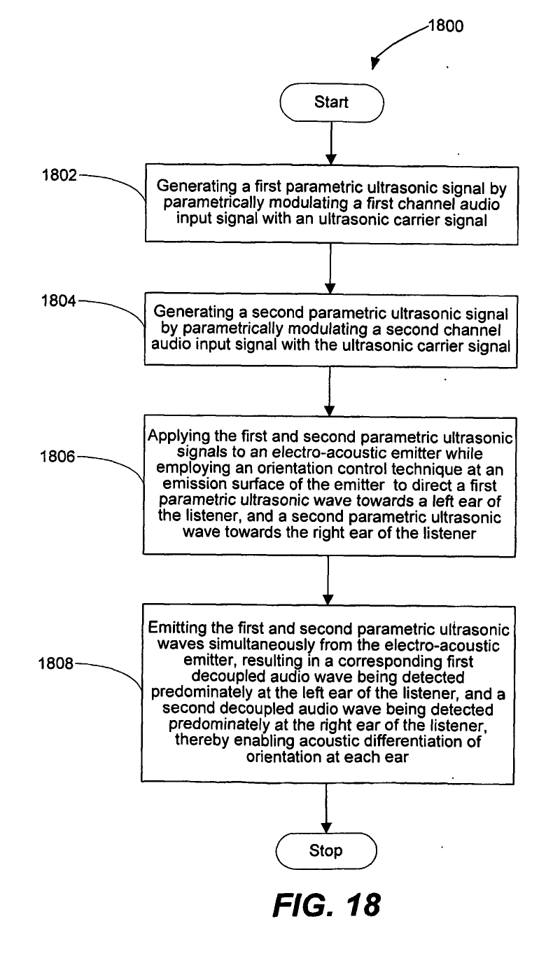

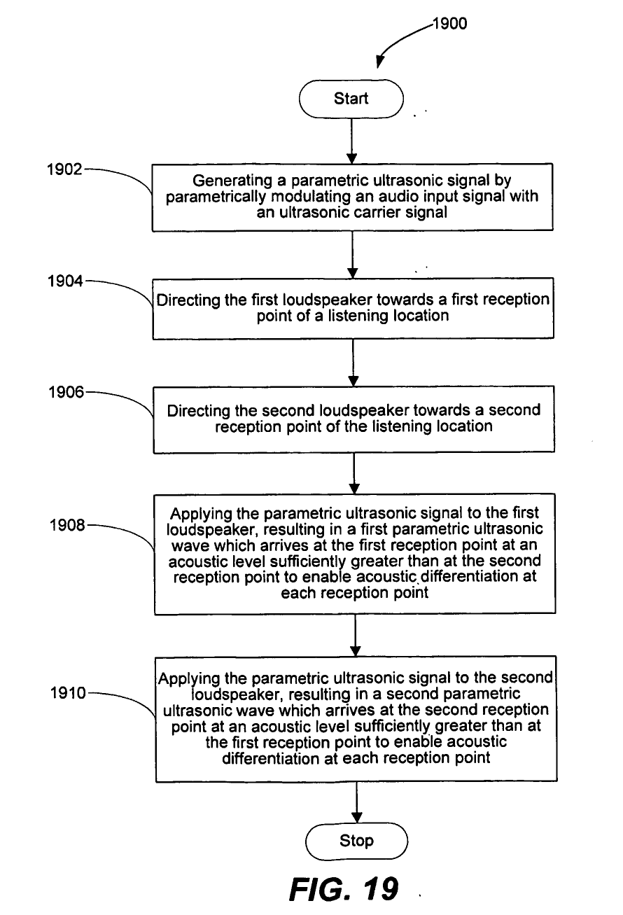

In accordance with FIG. 18, a method 1800 is disclosed for enabling binaural listening to audio material by a listener without need for earphones or other physical audio producing devices attached to the listener. Method 1800 may include generating 1802 a first parametric ultrasonic signal by parametrically modulating a first channel audio input signal with an ultrasonic carrier signal. Method 1800 may further include generating 1804 a second parametric ultrasonic signal by parametrically modulating a second channel audio input signal with the ultrasonic carrier signal. Method 1800 may further include applying 1806 the first and second parametric ultrasonic signals to an electro-acoustic emitter while employing an orientation control technique at an emission surface of the emitter to direct a first parametric ultrasonic wave towards a left ear of the listener, and a second parametric ultrasonic wave towards the right ear of the listener. Method 1800 may further include emitting 1808 the first and second parametric ultrasonic waves simultaneously from the electro-acoustic emitter, resulting in a corresponding first decoupled audio wave being detected predominately at the left ear of the listener, and a second decoupled audio wave being detected predominately at the right ear of the listener, thereby enabling acoustic differentiation of amplitudes arriving at each ear.

In one embodiment, the orientation control technique employed in step 1806 may include the differential phase controlling technique described in FIGS. 5-7.

In accordance with FIG. 19, a method 1900 is disclosed for minimizing cross-talk between output waves of at least a first and a second loudspeaker. The method 1900 may include generating 1902 a parametric ultrasonic signal by parametrically modulating an audio input signal with an ultrasonic carrier signal. Method 1900 may further include directing 1904 the first loudspeaker towards a first reception point of a listening location. Method 1900 may further include directing 1906 the second loudspeaker towards a second reception point of the listening location. Method 1900 may further include applying 1908 the parametric ultrasonic signal to the first loudspeaker, resulting in a first parametric ultrasonic wave which arrives at the first reception point at an acoustic level sufficiently greater than at the second reception point to enable acoustic differentiation of amplitudes arriving at each reception point. Method 1900 may further include applying 1910 the parametric ultrasonic signal to the second loudspeaker, resulting in a second parametric ultrasonic wave which arrives at the second reception point at an acoustic level sufficiently greater than at the first reception point to enable acoustic differentiation of amplitudes arriving at each reception point.

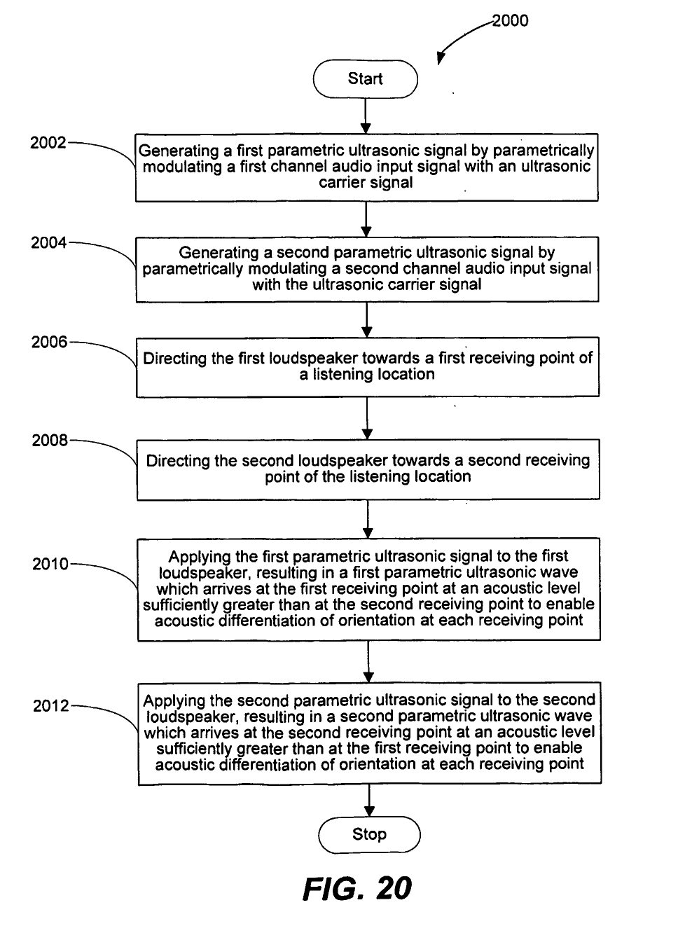

In accordance with FIG. 20, a method 2000 is disclosed for minimizing cross-talk between output waves of at least a first and a second loudspeaker. The method 2000 may include generating 2002 a first parametric ultrasonic signal by parametrically modulating a first channel audio input signal with an ultrasonic carrier signal. Method 2000 may further include generating 2004 a second parametric ultrasonic signal by parametrically modulating a second channel audio input signal with the ultrasonic carrier signal. Method 2000 may further include directing 2006 the first loudspeaker towards a first receiving point of a listening location. Method 2000 may further include directing 2008 the second loudspeaker towards a second receiving point of the listening location. Method 2000 may further include applying 2010 the first parametric ultrasonic signal to the first loudspeaker, resulting in a first parametric ultrasonic wave which arrives at the first receiving point at an acoustic level sufficiently greater than at the second receiving point to enable acoustic differentiation of amplitudes arriving at each receiving point. Method 2000 may further include applying 2012 the second parametric ultrasonic signal to the second loudspeaker, resulting in a second parametric ultrasonic wave which arrives at the second receiving point at an acoustic level sufficiently greater than at the first receiving point to enable acoustic differentiation of amplitudes arriving at each receiving point.

The listening locations of the methods 1700, 1900, and 2000 may be a predefined area wherein the first and second reception points are located. For example, the listening locations may be comprised of a three-dimensional volume, no larger than five foot by five foot by five foot in size, wherein the first and second reception points are located. Alternatively, the listening locations may be comprised of a personal space for an individual listener. In another embodiment, the listening locations may be comprised of an approximate environment surrounding a chair, wherein a listener may be situated.

The respective first and second reception points of the methods 1700, 1900, and 2000 may be first and second microphones, both situated within the listening location. In another embodiment, the respective first and second reception points are left and right ears of a listener, where the listener is the listening location.

In one embodiment, the above methods may include more than one listening location, each listening location having individual first and second reception points. By way of example, FIG. 8 portrays said method having multiple listening locations.

The above embodiments of the invention have many useful applications in addition to providing audio to a listener in a home entertainment system setting. For example, the invention may be included in commercial theaters to provide each audience member with a full surround-sound experience. The invention may also be used in video games, either in a user's home, or at a video arcade. Similarly, the invention may be included on amusement rides to provide the effect that sounds are approaching from various directions. Another application may be to include one or more of the above embodiments in a vehicle, such that each occupant of the car may enjoy a full surround-sound experience. Many other entertainment applications may be apparent to one skilled in the art.

In addition to entertainment applications, the present invention may have other uses, such as providing warning signals in various settings. For example, the invention may provide a driver of a vehicle with a warning sound signal indicating the direction from which another object is approaching the vehicle. Because of the binaural sound capabilities of the present invention, a virtual sound source can be created indicating the exact direction from which the object is approaching. Another similar application includes warning a pilot, either in an actual plane or in a flight simulator, of an approaching object. Similarly, an engineer of a train or a trolley may be provided with warning signals indicating the direction of oncoming cars, pedestrians, or other objects. Participants in various sport may also benefit from a warning signal being provided to indicate the position of nearby objects, such as other participants. As another application, a person who has poor vision, or total loss of vision, may be provided with sound signals indicating the position of objects in the environment surrounding him or her.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A virtual headset apparatus, facilitating isolation of first and second channel signals of audio material to be heard by a listener without need for placement of earphones or other audio transducer apparatus immediately adjacent the ears of a listener, comprising:
a parametric ultrasonic signal source supplying a first parametric channel signal including a first modulated ultrasonic carrier signal and a second parametric channel signal including a modulated ultrasonic carrier signal;
a first electro-acoustical emitter portion electrically coupled to said signal source and configured to create a first parametric ultrasonic signal beam directable to a first ear of a listener, conveying the first modulated ultrasonic carrier signal including said first parametric channel signal to be parametrically reproduced at the first ear isolated from reflections from a surrounding environment and from said second modulated ultrasonic carrier signal at the first ear; and
a second electro-acoustical emitter portion electrically coupled to said signal source and configured to create a second parametric ultrasonic signal beam directable to a second ear of a listener, conveying the second modulated ultrasonic carrier signal including a second parametric channel signal to be parametrically reproduced at the second ear isolated from reflections from a surrounding environment and from said first modulated ultrasonic carrier signal at the second ear;
the apparatus providing said first and second channel signals to said first and second ears so that audio material parametrically reproduced at the other of the first and second ear will be reduced sufficiently in sound pressure level at the other of the first and second ears that the first and second channel signals directed to each of the first and second ears, respectively, will predominate, and the apparatus can provide at least one of: (a) isolation of the listener from reflections in a listening environment; and, (b) facilitation of spatialization directly from said parametric channel signals without providing transducers immediately adjacent each ear.

2. The virtual headset of claim 1, wherein the second parametric channel signal is different from the first parametric channel signal

3. The virtual headset of claim 2, wherein the first and second parametric channel signals contain left and right audio channel information.

4. The virtual headset of claim 1, wherein one of said electro-acoustical emitter portions includes an electrically sensitive and mechanically responsive (ESMR) film.

5. The virtual headset of claim 1, further comprising phase-controlling circuitry to enable differential phase controlling of the first and second parametric ultrasonic beams as they are emitted from said first and second electro-acoustical emitter portions such that the first parametric ultrasonic wave beam may be directed at the first ear of the listener, wherein the electro-acoustical emitter structure includes multiple isolated emitting portions, at least two being driven by the first parametric ultrasonic channel signal, wherein at least one isolated emitting portion is driven with a signal having a phase differential as compared to the other isolated emitting portions to enable beam steering of the parametric ultrasonic beam.

6. The virtual headset of claim 1, further comprising a target element and a tracking circuit coupled to the electro-acoustical emitter portions for coordinating the first orientation of the first parametric ultrasonic beam to follow movement of the target element.

7. The virtual headset of claim 6, wherein the target element is the listener.

8. The virtual headset of claim 6, wherein the target element is worn by the listener to enable the tracking circuit to locate the position of the listener's ears.

9. The virtual headset of claim 5, wherein the phase controlling of the emitter portion generating at least the first parametric ultrasonic beam adjusts the phase differential in response to the movement of a target element to enable the first parametric ultrasonic wave to follow movement of the target element.

10. The virtual headset of claim 9, wherein a directional support structure for the electro-acoustical emitter is configured to rotate such that the orientation of an emission surface will adjust in response to the movement of the target element to enable the first parametric ultrasonic beam to follow movement of the target element.

11. A parametric loudspeaker system for enabling acoustic differentiation of amplitudes of audio material arriving at coordinated first and second reception points within a listening location, comprising: a. a parametric ultrasonic signal source supplying at least a first and a second parametric ultrasonic channel signal, each channel signal having an ultrasonic carrier signal and at least one sideband containing audio information; and b. an electro-acoustical emitter capable of orienting at least a first parametric ultrasonic wave corresponding to the first parametric ultrasonic channel signal along a first orientation for dominant reception at the first reception at an acoustic level substantially greater than at the second reception point, and a second parametric ultrasonic wave corresponding to the second parametric ultrasonic channel signal along a second orientation for dominant reception at the second reception point at an acoustic level substantially greater than at the first reception point, thereby enabling acoustic differentiation of amplitudes arriving at each reception point.

12. The parametric loudspeaker system of claim 11, wherein the respective first and second reception points are the first and second ears of a listener.

13. The parametric loudspeaker system of claim 11, wherein localized sound is generated at more than one listening location.

14. The parametric loudspeaker system of claim 11, further comprising phase controlling circuitry to enable differential phase controlling of at least the first and second parametric ultrasonic waves from the electro-acoustical emitter such that the first parametric ultrasonic wave may be directed at the first reception point and the second parametric ultrasonic wave at the second reception point, wherein the electro-acoustical emitter includes multiple isolated emitting portions, at least two being driven by the parametric ultrasonic signal source, wherein the first and second parametric ultrasonic channel signals applied to at least one isolated emitting portion have a phase differential as compared to the first and second parametric ultrasonic channel signals applied to other isolated emitting portions to enable beam steering of the first parametric ultrasonic wave along the first orientation and the second parametric ultrasonic wave along the second orientation.

15. The parametric loudspeaker system of claim 14, wherein the phase controlling of the parametric ultrasonic waves and the electro-acoustical emitter are configured for directing the first and second parametric ultrasonic waves; towards the first and second reception points of more than one listening location.

16. A method for enabling binaural listening to audio material by a listener without need for earphones or other physical audio producing devices attached to the listener, the method comprising:
a. generating a first parametric ultrasonic signal by parametrically modulating a first channel audio input signal with an ultrasonic carrier signal;
b. generating a second parametric ultrasonic signal by parametrically modulating a second channel audio input signal with the ultrasonic carrier signal;
c. applying the first and second parametric ultrasonic signals to an electro acoustic emitter while employing an orientation control technique at an emission surface of the emitter to direct a first parametric ultrasonic wave towards a left ear of the listener, and a second parametric ultrasonic wave towards the right ear of the listener; and
d. emitting the first and second parametric ultrasonic waves simultaneously from the electro-acoustic emitter, resulting in a corresponding first decoupled audio wave being detected predominately at the left ear of the listener, and a second decoupled audio wave being detected predominately at the right ear of the listener, thereby enabling acoustic differentiation of amplitudes arriving at each ear.

17. The method of claim 16, wherein the employing of an orientation control technique more specifically includes performing differential phase controlling of the first and second parametric ultrasonic waves from the electro-acoustical emitter, further comprising driving at least two isolated emitting portions of the electro-acoustical emitter with the first and second parametric ultrasonic signals, wherein the first and second parametric ultrasonic signals applied to at least one isolated emitting portion have a phase differential as compared to the first and second parametric ultrasonic channel signals applied to other isolated emitting portions to enable beam steering of the parametric ultrasonic waves.

18. A method for creating a virtual headset minimizing cross-talk between output waves of at least a first audio output device and a second audio output device, the method comprising:
a. generating a first parametric ultrasonic signal by parametrically modulating a first channel audio input signal with an ultrasonic carrier signal;
b. generating a second parametric ultrasonic signal by parametrically modulating a second channel audio input signal with the ultrasonic carrier signal;
c. directing the first audio output device towards a first reception point of a listening location;
d. directing the second audio output device towards a second reception point of the listening location;
e. applying the first parametric ultrasonic signal to the first audio output device, resulting in a first parametric ultrasonic wave which arrives at the first receiving point at an acoustic level sufficiently greater than at the second receiving point to enable acoustic differentiation of amplitudes arriving at each reception point; and
f. simultaneously applying the second parametric ultrasonic signal to the second audio output device, resulting in a second parametric ultrasonic wave which arrives at the second receiving point at an acoustic level sufficiently greater than at the first receiving point to enable acoustic differentiation of amplitudes arriving at each reception point.

19. The method of claim 18, wherein the respective first and second reception points are left and right ears of a listener.

20. The method of claim 19, further comprising: tracking the location of the listener; and, beam-steering the output waves of the first and second audio output devices towards said left and right ears.
